(19) United States
(12) Patent Application Publication
(10) Pub. No.: US 2016/0299929 A1
(43) Pub. Date: Oct. 13, 2016

(54) SPATIAL KNOWLEDGE EXTRACTOR AND EXTRACTION METHOD USING THE SAME

(71) Applicant: Foundation of Soongsil University-Industry Cooperation, Seoul (KR)

(72) Inventors: Youngtack PARK, Seoul (KR); Incheol KIM, Seongnam-si (KR); Seokjun LEE, Pyeongtaek-si (KR)

(21) Appl. No.: 15/009,243

(22) Filed: Jan. 28, 2016

(30) Foreign Application Priority Data
Apr. 13, 2015 (KR) 10-2015-0051969

(51) Int. Cl. G06F 17/30

(52) U.S. Cl. CPC G06F 17/30327; G06F 17/30424

(57) ABSTRACT

Disclosed within is a spatial knowledge extractor and a method of extracting spatial knowledge. The spatial knowledge extractor constructs an R-tree index, which is a minimum bounding rectangle (MBR)-based tree data structure, for geometric data about a plurality of spatial objects and extracts topological relation knowledge and directional relation knowledge about the spatial objects using MBRs constructed by the R-tree index and central points of the MBRs to extract spatial knowledge from geometric data about spaces.

### CROSS-REFERENCE TO RELATED APPLICATION

This application claims priority to and the benefit of Korean Patent Application No. 10-2015-0051969, filed on Apr. 13, 2015, the disclosure of which is incorporated herein by reference in its entirety.

### BACKGROUND

1. Field of the Invention

The present invention relates to a spatial knowledge extractor and an extraction method using the same, and more particularly, to a spatial knowledge extractor for isolating spatial knowledge about a topological relation and a directional relation between spatial objects from geometric data and an extraction method using the same.

2. Discussion of Related Art

Recently, as various services that utilize spatial information in a mobile computing environment or a wearable computing environment are available, there has been increased interest in spatial information processing technology.

Particularly, large-scale spatial knowledge bases and spatial databases that are released by the government or private sector such as Open Street Map, United States Geological Survey, or OS Open Data are increased, and the development of their application services is well underway.

However, a spatial database containing specific geometric data for each spatial object according to a certain schema may have a very large volume, but may have difficulty with intuitively determining a relation between spatial objects which is required in an daily life. Accordingly, many spatial information services require spatial knowledge presented by an implicit language, or at least are expected to allow knowledge-level spatial queries and responses thereto. However, in comparison with spatial databases, the construction of spatial knowledge bases is a high-level work that is difficult to automate, and needs manual labor corresponding with the decisions and definitions of a skilled knowledge engineer. Therefore, it is not easy to secure high-quality quality spatial knowledge.

There are existing methods for securing such high-quality spatial knowledge, that is, a method of expanding a knowledge base through spatial reasoning and a method of extracting spatial knowledge from a machine-learning-based web document. However, a knowledge materialization method through the existing spatial reasoning has limitations in that the method is available only when there is sufficient preliminary high-quality spatial knowledge. Furthermore, the method of automatically finding certain patterns from web documents through a mechanical learning technique has a low performance and low reliability of acquired knowledge, and thus it is difficult to practically apply.

Accordingly, this situation needs a spatial knowledge extraction scheme for automatically extracting qualitative knowledge indicating a topological relation and a directional relation between spatial objects that are available according to a standard model from geometric data of the spatial objects.

### SUMMARY OF THE INVENTION

The present invention is directed to a spatial knowledge extractor that isolates a topological relation and a directional relation between spatial objects from geometric data using an R-tree index, which is a minimum bounding rectangle (MBR)-based tree data structure, and an extraction method using the same.

According to an aspect of the present invention, there is a spatial knowledge extractor provided including: an index builder configured to construct an R-tree index for geometric data about a plurality of spatial objects; and a geometry analyzer including a topological relation analyzer configured to analyze a topological relation between the plurality of spatial objects according to whether minimum bounding rectangles (MBRs) constructed for the spatial objects by the index builder overlaps one another, and a directional relation analyzer configured to perform a range query for each of areas divided with respect to a central point of an MBR including any spatial reference object among the MBRs constructed for the spatial objects and to analyze a directional relation between the plurality of spatial objects.

The topological relation analyzer may classify the MBRs constructed for the spatial objects into an MBR including any spatial reference object and MBRs including spatial objects other than the spatial reference object and may analyze a spatial object included in an MBR not overlapping the MBR including the spatial reference object among the MBRs including the spatial objects other than the spatial reference object as having a topological relation of “the spatial object is disjoint from the spatial reference object.”

The topological relation analyzer may examine the topological relation by calculating a dimensionally extended nine-intersection model (DE-9IM) intersection matrix of a spatial object included in an MBR overlapping the MBR including the spatial reference object among the MBRs including the spatial objects other than the spatial reference object.

The directional relation analyzer may display central points of the MBRs constructed for the spatial objects by the index builder and a root MBR including all of the MBRs constructed for the spatial objects by the index builder, may divide the root MBR into a plurality of areas according to a directional relation with respect to the central point of the MBR including the spatial reference object, and may perform a range query on each of the plurality of divided areas to analyze a directional relation between the plurality of spatial objects.

The directional relation analyzer may perform a predetermined range query corresponding to each of the areas divided with respect to the central point of the MBR including the spatial reference object and may analyze a directional relation with the spatial reference object according to a query result of the range query performed on each area.

As a result of performing the predetermined range query corresponding to each area, the directional relation analyzer may analyze all spatial objects included in an MBR having the query result corresponding to the range query as having a directional relation corresponding to the range query with the spatial reference object.

When there is a central point on a boundary of each area divided with respect to the central point of the MBR including the spatial reference object, the directional relation analyzer may calculate a directional angle between the central point on the boundary and the central point of the MBR including the spatial reference object and may analyze a directional relation of a spatial object included in an MBR corresponding to the central point on the boundary.

According to another aspect of the present invention, there is provided a method of extracting spatial knowledge, the method including: constructing an R-tree index for geometric data about a plurality of spatial objects; analyzing a topological relation between the plurality of spatial objects according to whether minimum bounding rectangles (MBRs) constructed for the spatial objects by the R-tree index overlaps one another; and performing a range query for each of the areas divided with respect to a central point of an MBR including any spatial reference object among the MBRs constructed for the spatial objects and analyzing a directional relation between the plurality of spatial objects to extract spatial knowledge about the plurality of spatial objects from the geometric data.

The analyzing of a topological relation between the plurality of spatial objects may include classifying the MBRs constructed for the spatial objects into an MBR including any spatial reference object and MBRs including spatial objects other than the spatial reference object and analyzing a spatial object included in an MBR not overlapping the MBR including the spatial reference object among the MBRs including the spatial objects other than the spatial reference object as having a topological relation of “the spatial object is disjoint from the spatial reference object.”

The method may further include calculating a dimensionally extended nine-intersection model (DE-9IM) intersection matrix of a spatial object included in an MBR overlapping the MBR including the spatial reference object among the MBRs including the spatial objects other than the spatial reference object to analyze the topological relation.

The analyzing of a directional relation between the plurality of spatial objects may include displaying central points of the MBRs constructed for the spatial objects by an index builder and a root MBR including all of the MBRs constructed for the spatial objects by the index builder, dividing the root MBR into a plurality of areas according to a directional relation with respect to the central point of the MBR including the spatial reference object, performing a predetermined range query on each of the plurality of divided areas, and, as a result of performing the range query, analyzing all spatial objects included in an MBR having the query result corresponding to the range query as having a directional relation corresponding to the range query with the spatial reference object.

The method may further include, when there is a central point on a boundary of each area divided with respect to the central point of the MBR including the spatial reference object, calculating a directional angle between the central point on the boundary and the central point of the MBR including the spatial reference object and analyzing a directional relation with a spatial object included in an MBR corresponding to the central point on the boundary.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows a control block diagram of a spatial knowledge extractor according to an embodiment of the present invention;

FIG. 2 is a conceptual diagram showing a method of expressing a relation between spatial objects;

FIG. 3 is a diagram showing an example of spatial knowledge described according to a knowledge expression system;

FIG. 4 is a diagram showing “Seoul” and “HanGang” on a map;

FIG. 5 is a diagram for describing an R-tree index;

FIG. 6 is a diagram showing R-tree index construction of spatial objects and a minimum bounding rectangle (MBR);

FIG. 7 is a diagram showing a dimensionally extended nine-intersection model (DE-9IM) intersection matrix of two spatial objects;

FIG. 8 is a diagram showing an area of a directional angle formed between a central point between a root MBR and a spatial object MBR and a central point of a reference MBR;

FIG. 9 is a diagram for describing a method of calculating a directional angle between two spatial objects;

FIG. 10 is a diagram showing a graphical user interface of a spatial knowledge extractor according to an embodiment of the present invention;

FIG. 11 is a diagram for verifying the performance for the processing time of a spatial knowledge extractor using Open Street Map according to an embodiment of the present invention;

FIG. 12 is a diagram for verifying the performance for the processing time of a spatial knowledge extractor using USGS according to an embodiment of the present invention;

FIG. 13 is a diagram showing an example of spatial knowledge about two spatial objects extracted by a spatial knowledge extractor according to an embodiment;

FIG. 14 is a diagram showing actual spatial knowledge about two spatial objects used to extract the spatial knowledge in FIG. 13;

FIG. 15 is a flowchart showing a method of extracting spatial knowledge according to an embodiment of the present invention;

FIG. 16 is a detailed flowchart showing a step of extracting a topological relation shown in FIG. 15; and

FIG. 17 is a detailed flowchart showing a step of extracting a directional relation shown in FIG. 15.

### DETAILED DESCRIPTION OF EXEMPLARY EMBODIMENTS

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different, are not necessarily mutually exclusive. For example, a particular feature, structure, or characteristic described herein, in connection with one embodiment, may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, if appropriately interpreted, along with the full range of equivalents to which the claims are entitled. In the drawings, like numerals refer to the same or similar elements throughout the several views.

Hereinafter, preferred embodiments of the present invention will be described in more detail with reference to the accompanying drawings.

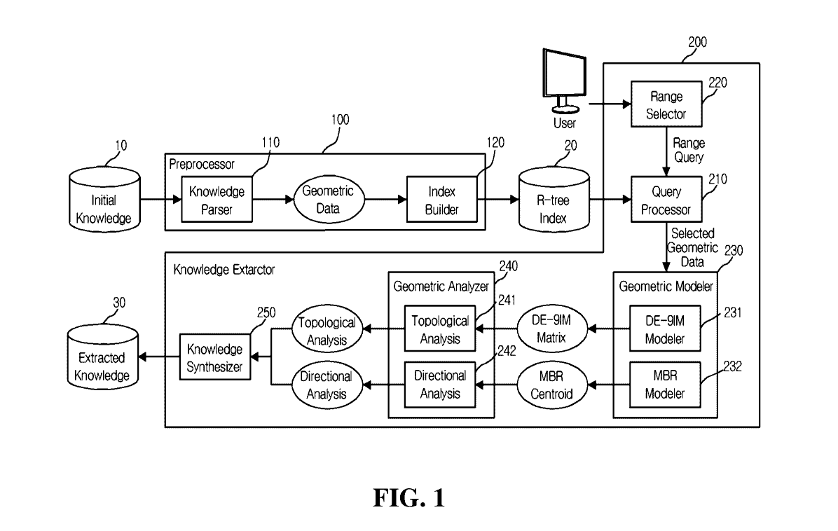

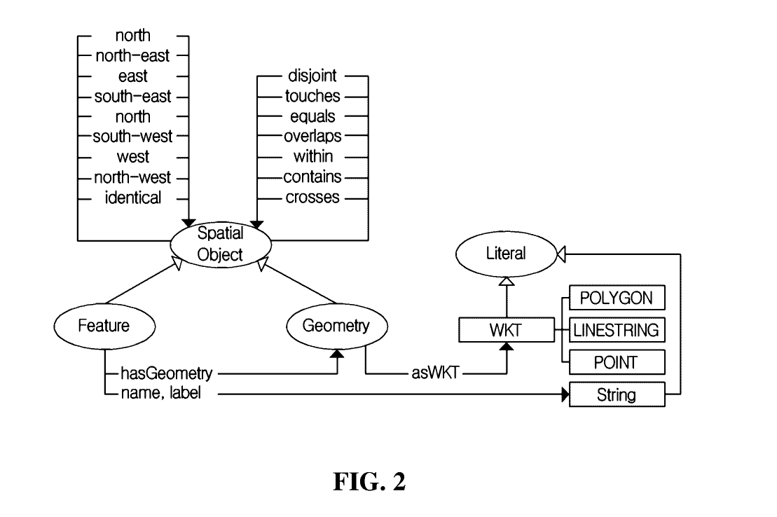

FIG. 1 shows a control block diagram of a spatial knowledge extractor according to an embodiment of the present invention, and FIG. 2 is a conceptual diagram showing a method of expressing a relation between spatial objects.

A spatial knowledge extractor 1 according to an embodiment of the present invention may construct an R-tree index, which is a minimum bounding rectangle (MBR)-based tree data structure for a plurality of spatial objects expressed by geometric data, and may extract spatial knowledge about the spatial objects from geometric data using the constructed R-tree index. Before describing the spatial knowledge extractor 1 according to an embodiment of the present invention, how to express spatial knowledge as a target of extraction, that is, a spatial knowledge expression system first needs to be defined in order to extract the spatial knowledge from the geometric data. The spatial knowledge according to an embodiment of the present invention may be expressed using a (s p o)-type triple statement according to RDF/OWL, which is a semantic web standard ontology language.

Referring to FIG. 2, a spatial object is in the highest class indicating all spatial objects. A boundary and inclusive relation between two spatial objects may be expressed using seven total topological properties which are, disjoint, touches, equals, overlaps, within, contains, and crosses. In addition, a directional relation between two spatial objects may be expressed using nine total directional properties, which are, north, north-east, east, south-east, south, south-west, west, north-west, and identical.

As shown in FIG. 2, features and geometry are lower classes of the spatial object. The feature may denote a specific place such as a city, a road, and a building, and the geometry may denote geometric data of the feature such as a point, a linestring, and a polygon. In this case, the feature may be expressed as a string type literal, and the geometric data of the geometry may be expressed as a well-known text (WKT) type literal. In this case, the WKT may be a standard text mark-up language for expressing various vector geometry objects such as a point, a linestring, and a polygon.

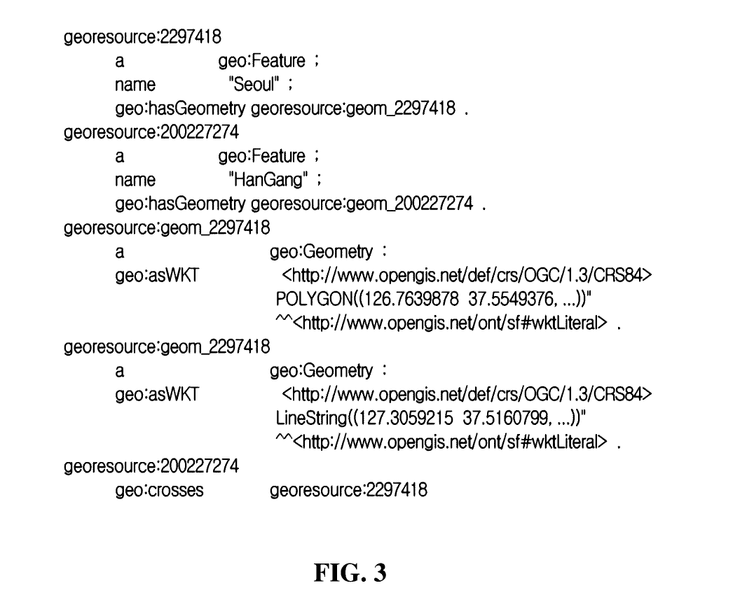

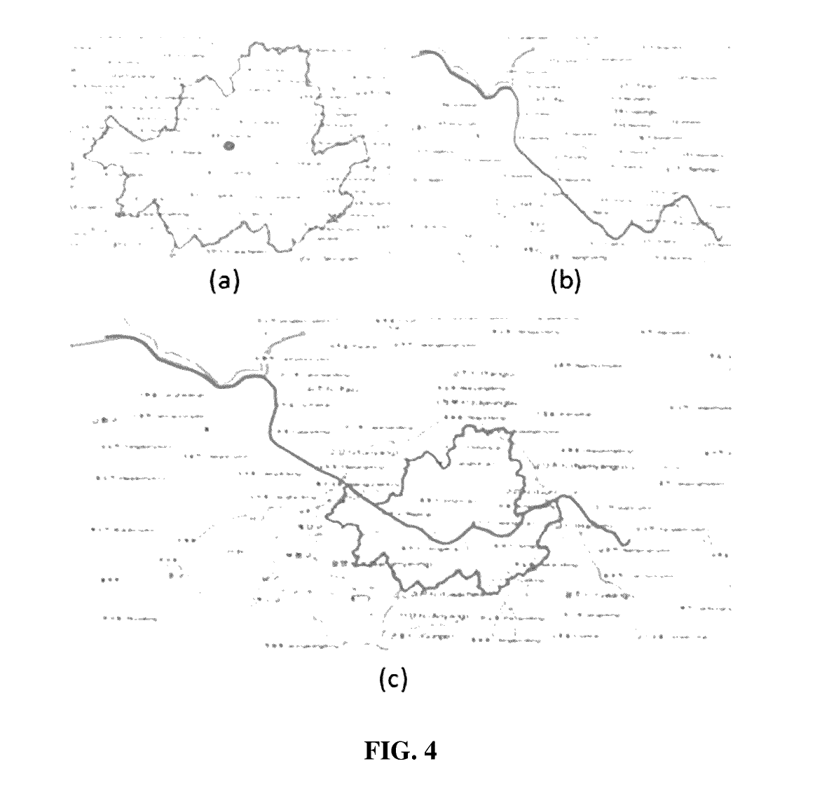

FIG. 3 is a diagram showing an example of spatial knowledge described according to a knowledge expression system, and FIG. 4 is a diagram showing “Seoul” and “HanGang” on a map.

In FIG. 3, “Seoul” and “HanGang” have geometric data through respective separate geometries. That is, the geometry of “Seoul” may be expressed using a polygon (geom_2297418asWKT POLYGON)-type literal composed of two-dimensional coordinates, and the geometry of “HanGang” may be expressed using a linestring (geom_200227274asWKT POLYGON)-type literal composed of two-dimensional coordinates. In addition, the spatial knowledge described according to the knowledge expression system in FIG. 3 includes topological relation knowledge “HanGang crosses Seoul (200227274 crosses 2297418).” Referring to FIG. 4, FIG. 4A shows “Seoul,” FIG. 4B shows “HanGang,” and FIG. 4C shows “Seoul” and “HanGang” together. FIG. 4 implies that, when geometric data stored in the geometry such as “Seoul” and “HanGang” is used, a spatial relation knowledge that “HanGang crosses Seoul ” may be induced as shown in FIG. 4C. It can be seen that the knowledge extraction method using the geometric data may be another important means for inducing the spatial knowledge, in addition to the existing spatial reasoning or mechanical learning method.

Referring to FIG. 1, the spatial knowledge extractor 1 according to an embodiment of the present invention may include a preprocessor 100 and a knowledge extractor 200. The preprocessor 100 may include a knowledge parser 110 and an index builder 120. The knowledge extractor 200 may include a query processor 210, a range selector 220, a geometric modeler 230, a geometric analyzer 240, and a knowledge synthesizer 250.

The knowledge parser 110 may separate geometric data composed of a point, a linestring, and a polygon from an initial knowledge database 10 with reference to spatial ontology.

The index builder 120 may construct an R-tree index for geometric data composed of a point, a linestring, and a polygon that is extracted by the knowledge parser 110. The index builder 120 may store the geometric data having the R-tree index constructed therein in an R-tree index database 20.

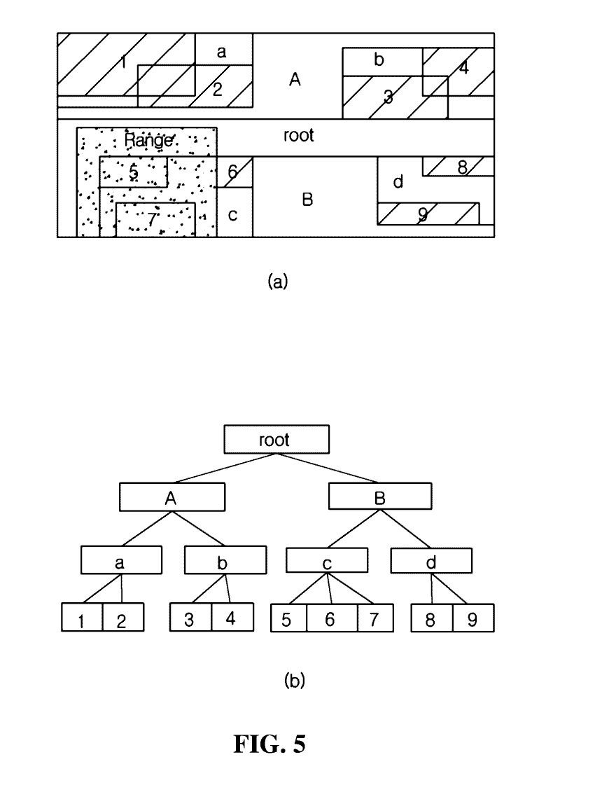

In this case, an R-tree is an index for storing multi-dimensional spatial data and may be a tree data structure for efficiently accessing a multi-dimensional vector geometry object. The R-tree may divide space into minimum bounding rectangles (MBRs) and may store the divided space. In this case, the MBR may denote a minimum bounding rectangle that surrounds spatial objects included in the geometric data. FIG. 5 is a diagram for describing an R-tree index. Referring to FIG. 5, when the R-tree index is performed, the nearest neighbors may be grouped using MBRs of spatial objects. For example, in FIG. 5A, an MBR of 1 and 2 may be grouped as an MBR of a, an MBR of 3 and 4 may be grouped as an MBR of b, an MBR of 5, 6, and 7 may be grouped as an MBR of c, and an MBR of 8 and 9 may be grouped as an MBR of d. Furthermore, the MBR of a and b may be grouped as an MBR of A, and the MBR of c and d may be grouped as an MBR of B. The grouped MBRs may form layers for each step. As shown in FIG. 5B, a hierarchical data structure may be constructed.

Each node of the R-tree includes an MBR, and thus may efficiently perform a range query. Assuming that a query corresponding to a range is performed in FIG. 5A, the lowest node c may be accessed by starting searching from a root node and selecting only a node intersecting with an area of the range query (root→B→c). When the node c is accessed, a spatial object of node c may be read out from a disc and may be checked whether it is contained in the area of the range query; and then, a result thereof may be produced.

When a user requests a range query on a two-dimensional space using the range selector 220, the query processor 210 may perform a range query on the R-tree index constructed by the index builder 120.

The geometric modeler 230 may include a dimensionally extended nine-intersection model (DE-9IM) modeler 231 and an MBR modeler 232, and may calculate a DE-9IM intersection matrix and central points of a plurality of MBRs from the result of the query processor 210 performing the range query (selected geometric data).

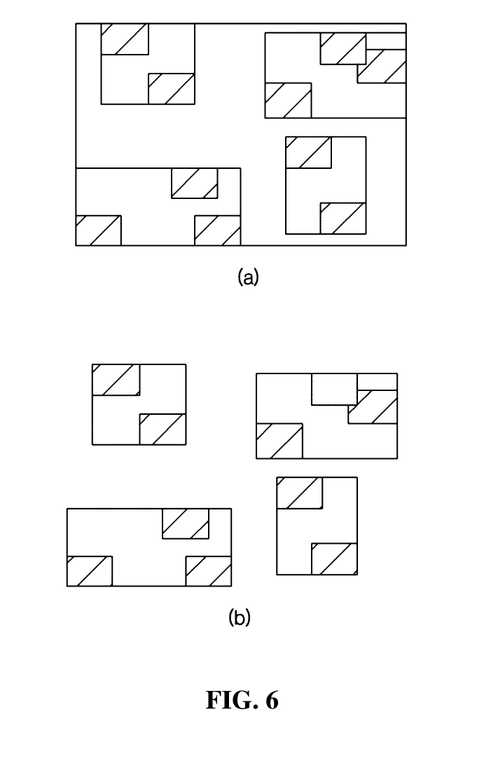

Here, the DE-9IM intersection matrix is a method of determining one of seven topological relations (disjoint, touches, equals, overlaps, within, contains, and crosses) that are satisfied between two spatial objects. FIG. 6 is a diagram showing a DE-9IM intersection matrix of two spatial objects. Referring to FIG. 6, rows and columns of the DE-9IM intersection matrix denote an interior, a boundary, an exterior of the geometric data. According to an example of the DE-9IM intersection matrix, a dimension may be 2(dim[I(a)∩I(b)]=2) because an intersection set between an interior of a and an interior of b is a polygon, and may be 1(dim[I(a)∩B(b)]=1) because an intersection set between an interior of a and a boundary of b is a linestring. Assuming that the intersection set is an empty set 0, the dimension may be −1. In the result of the matrix, the dimensions may be arranged from top to bottom and from left to right. Accordingly, the result of the matrix of FIG. 6 may be expressed as 212101212, or TTTTTTTTT in a Boolean context. When the DE-9IM intersection matrix is calculated, a topological relation between two spatial objects may be determined according to a decision table of Table 1.

TABLE 1

| Spatial | Applies to | DE-9IM |
|---|---|---|
| Property Name | Geometry Types | Intersection Pattern |
| disjoint | All | (FF*FF****) |
| touches | All except P/P | (FT*******, F**T*****, |
| | | F***T****) |
| equals | All | (TFFFTFFFT) |
| overlaps | A/A, P/P, L/L | (T*T***T**) for A/A, P/P; |
| | | (1*T***T**) for L/L |
| within | All | (T*F**F***) |
| contains | All | (T*****FF*) |
| crosses | P/L, P/A, L/A, L/L | (T*T***T**) for P/L, P/A, L/A; |
| | | (0********) for L/L |

The geometric analyzer 240 may analyze a topological relation and a directional relation between the spatial objects using MBRs constructed by the R-tree index. To this end, the geometric analyzer 240 may include a topological relation analyzer 241 and a directional relation analyzer 242.

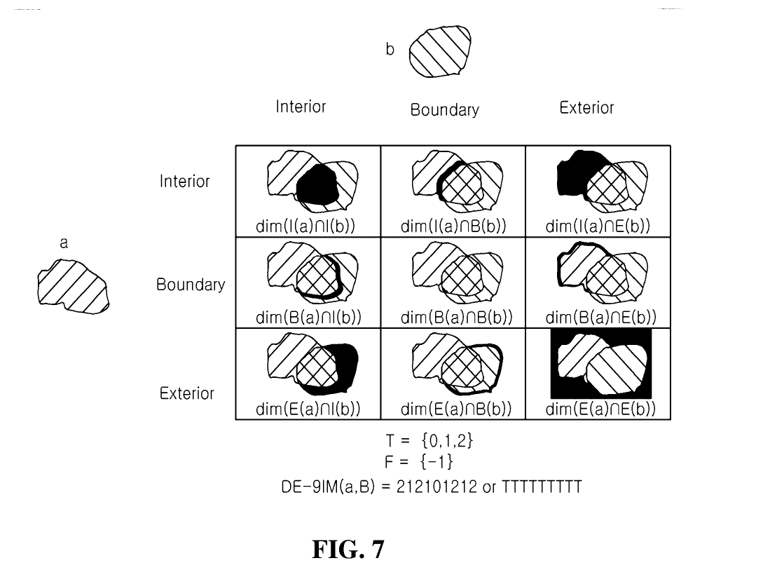

The topological relation analyzer 241 may analyze a topological relation with the spatial object according to whether the MBRs constructed by the R-tree index overlap one another. The topological relation analyzer 241 may analyze the topological relation between the spatial objects through FIG. 7. FIG. 7 is a diagram for describing a method of extracting the topological relation between the spatial objects.

In detail, the topological relation analyzer 241 may select any one of a plurality of spatial objects as a spatial reference object. In this case, the spatial reference object may be sequentially selected according to a predetermined selection pattern. As shown in FIG. 7B, the topological relation analyzer 241 may classify the constructed MBRs into MBRs including the selected spatial reference object (e.g., an MBR of which interior is represented with dots in FIG. 7B) and MBRs including spatial objects other than the spatial reference object (e.g., an MBR of which interior is represented with diagonal lines). The topological relation analyzer 241 may detect an MBR overlapping the MBR including the spatial reference object or an MBR not overlapping the MBR including the spatial reference object among the MBRs including the spatial objects other than the spatial reference object. The topological relation analyzer 241 may omit a process of calculating the DE-9IM intersection matrix of the MBRs not overlapping the MBR including the spatial reference object. All the spatial objects included in the corresponding MBR may be analyzed as having a topological relation of “the spatial objects are disjoint from the spatial reference object.” The topological relation analyzer 241 may calculate the DE-9IM intersection matrix of the MBR overlapping the MBR including the spatial reference object to analyze the topological relation between the spatial object included in the MBR and the spatial reference object. In this case, the topological relation analyzer 241 may calculate the DE-9IM intersection matrix of a few spatial objects included in the MBR overlapping the MBR including the spatial reference object to analyze the topological relation between the spatial object included in the MBR and the spatial reference object. Thus, the topological relation analyzer 241 may increase efficiency of the calculation by calculating the DE-9IM intersection matrix of only the MBR overlapping the MBR including the spatial reference object.

As described above, the spatial reference object may be sequentially selected according to a predetermined selection pattern. When the analysis of the topological relation between any spatial reference object and the other spatial objects is completed, the topological relation analyzer 241 may select the next spatial object as a spatial reference object according to the predetermined selection pattern and analyze the topological relation. The topological relation analyzer 241 may sequentially select all spatial objects as a spatial reference object and may acquire a topological relation with respect to each of the spatial objects.

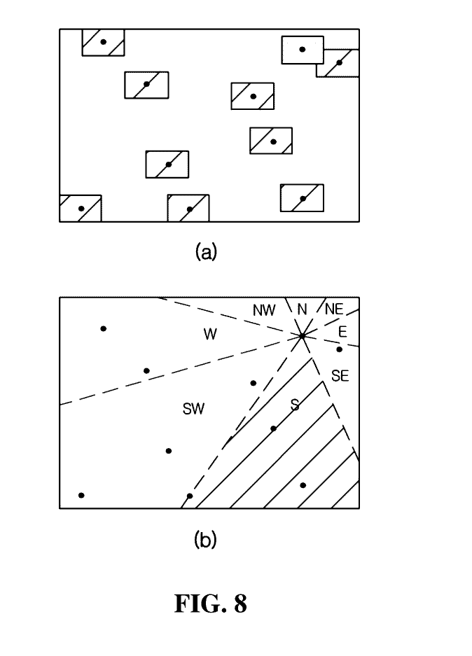

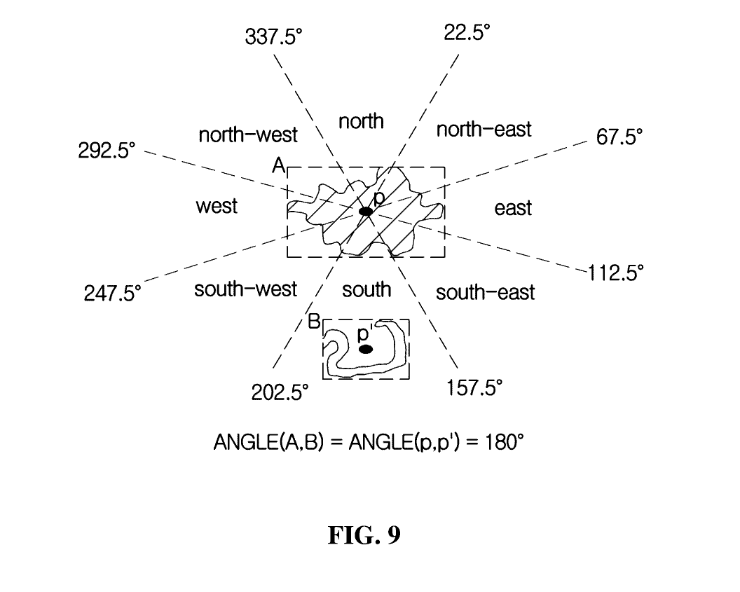

The directional relation analyzer 242 may perform a range query on an area divided with respect to a central point of any MBR among the MBRs constructed by the R-tree index and may analyze a directional relation between spatial objects. The directional relation analyzer 242 may analyze a directional relation between spatial objects through FIGS. 8 and 9. FIG. 8 is a diagram for describing a method of extracting the directional relation between the spatial objects, and FIG. 9 is a diagram for describing a method of calculating a directional angle between the two spatial objects.

In detail, as shown in FIG. 8A, the directional relation analyzer 242 may generate a root MBR including MBRs of all spatial objects and may display a central point of each MBR included in the root MBR. The directional relation analyzer 242 may divide the root MBR into a plurality of areas according to the directional relation with respect to a central point of an MBR including any spatial reference object among the MBRs included in the root MBR. In this case, the directional relation may denote nine directional relations (north, north-east, east, south-east, south, south-west, west, north-west, and identical) according to the Cone-Shaped Directional(CSD)-9. Thus, the directional relation analyzer 242 may divide the root MBR into eight areas according to the nine directional relations according to the CSD-9 as shown in FIG. 9. The directional relation analyzer 242 may perform a corresponding range query on each of the divided areas of the root MBR. In this case, the range query may be provided in advance for each divided area, that is, for each directional relation.

As a result of performing the range query, the directional relation analyzer 242 may analyze the spatial reference object and all spatial objects that are included in an MBR having a query result corresponding to the performed range query as having a directional relation corresponding to the performed range query. For example, as shown in FIG. 8B, as a result of performing a range query corresponding to a southern area, the directional relation analyzer 242 may analyze all spatial objects included in two MBRs for two central points as being located in the south of the spatial reference object when the MBRs have a query result corresponding to the range query corresponding to the south area.

Like a central point in the vicinity of a central bottom in FIG. 8B, when there is a central point on a boundary of the divided areas in the root MBR, the directional relation analyzer 242 may calculate a directional angle with respect to the central point of the MBR including the spatial reference object to analyze a corresponding directional relation. In more detail, the directional relation analyzer 242 may calculate a directional angle between the central point on the boundary of the divided areas in the root MBR and a central point of the MBR including the spatial reference object through Equation 1 below:

$$ANGLE ( p , {p}^{′} ) = ar tan ( \frac{{p}_{y}^{′} - {p}_{y}}{{p}_{x}^{′} - {p}_{x}} ) \times 180 / π , \qquad [ Equation 1 ]$$

where Pₓ and P_{y} are x and y coordinates of the central point of the MBR including the spatial reference object, and P′ₓ and P′_{y} are x and y coordinates of the central point on the boundary.

When a directional angle between the central points of two MBRs is calculated, the directional relation analyzer 242 may analyze a directional relation between two spatial objects according to a decision table of Table 2. For example, when a directional angle between a central point of an MBR surrounding “Seoul” and a central point of an MBR of “Suwon” is 180°, directional relation knowledge of “Seoul is located in the north of Suwon” may be acquired.

TABLE 2

| Spatial | Applies to | |
|---|---|---|
| Property Name | Geometry Types | Angle |
| north | All | (0°~22.5°), (337.5°~360°) |
| north-east | All | (22.5°~67.5°) |
| east | All | (67.5°~112.5°) |
| south-east | All | (112.5°~157.5°) |
| south | All | (157.5°~202.5°) |
| south-west | All | (202.5°~247.5°) |
| west | All | (247.5°~292.5°) |
| north-west | All | (292.5°~337.5°) |
| identical | All | P = P′ (no angle) |

The spatial reference object may be sequentially selected according to a predetermined selection pattern. When the analysis of the directional relation between any spatial reference object and the other spatial objects is completed, the directional relation analyzer 242 may select the next spatial object as a spatial reference object according to the predetermined selection pattern and analyze the directional relation. The directional relation analyzer 242 may sequentially select all spatial objects as a spatial reference object and may acquire directional relation knowledge with respect to each of the spatial objects.

The knowledge synthesizer 250 may generate triple-type qualitative spatial knowledge using descriptors defined in ontology on the basis of a topological relation and a directional relation between geometric data analyzed or extracted by the geometric analyzer 240. The knowledge synthesizer 250 may store the generated triple-type qualitative spatial knowledge in an extracted knowledge database 30.

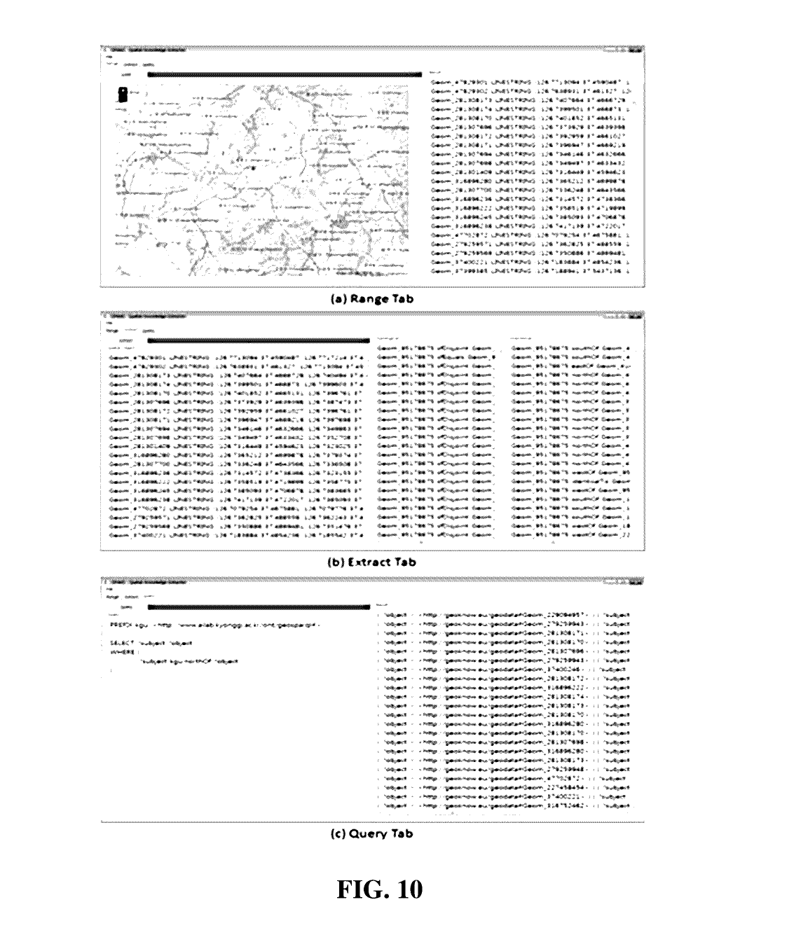

FIG. 10 is a diagram showing a graphical user interface of a spatial knowledge extractor according to an embodiment of the present invention.

As shown in FIG. 10A, the graphical user interface implemented on the basis of a structure of the spatial knowledge extractor 1 according to an embodiment of the present invention may provide a map browser for designating the range of geometric data from which the spatial knowledge is to be extracted. In this case, the map browser may be enlarged, reduced, and moved by the user, and the spatial knowledge extractor may set a map screen that is enlarged, reduced, or moved by the user through the graphical user interface as the range and may perform a range query. As shown in a right side of FIG. 10A, the spatial knowledge extractor 1 may output geometric data, which is a result of the range query performed by the graphical user interface, in addition to a map browser. The spatial knowledge extractor 1 may extract spatial knowledge on the basis of the geometric data that is the range query result. As shown in FIG. 10B, the spatial knowledge extractor 1 may output geometric data, which is a result of the range query previously performed in a left screen of the graphical user interface, and may output extracted topological relation knowledge and directional relation knowledge to a right screen in the form of a triple. The spatial knowledge extractor 1 may support GeoSPATQL query processing to a user through the graphical user interface. In this case, as shown in FIG. 10C, the spatial knowledge extractor 1 may output a screen for receiving a query on the left screen of the graphical user interface and may receive a query from the user and output the result to the right screen.

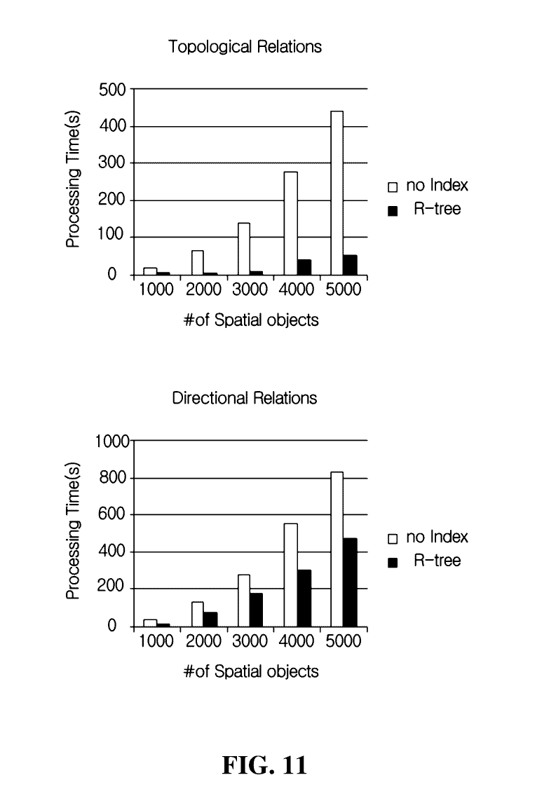

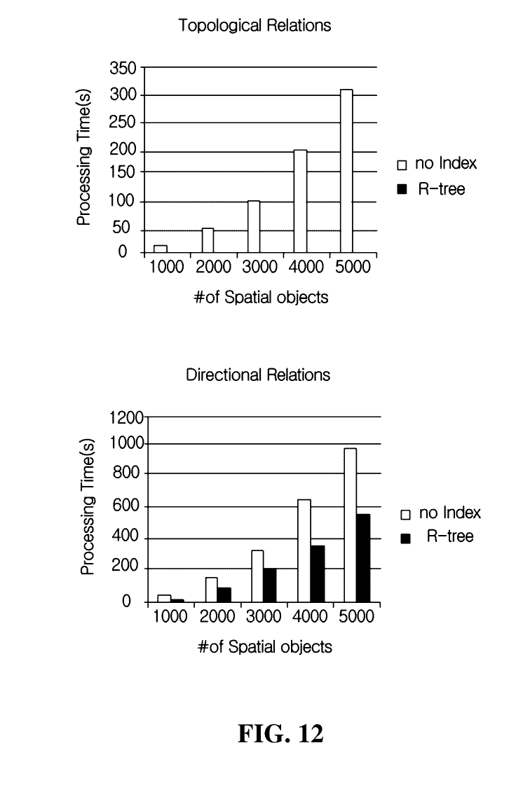

The performance of the spatial knowledge extractor 1 according to an embodiment of the present invention will be verified below with reference to FIGS. 11 and 12. In this case, FIG. 11 is a diagram for verifying the performance for a processing time of a spatial knowledge extractor using Open Street Map according to an embodiment of the present invention, and FIG. 12 is a diagram for verifying the performance for a processing time of a spatial knowledge extractor using USGS according to an embodiment of the present invention.

In order to evaluate the performance of the spatial knowledge extractor 1 according to an embodiment of the present invention, a performance analysis experiment of the spatial knowledge extractor 1 was conducted using a spatial knowledge database released by Open Street Map and U.S. Geological Survey (USGS). Table 3 is a database used for the performance analysis experiment.

TABLE 3

| | Measure | | | | |
|---|---|---|---|---|---|
| Database | Coverage | Point(#) | Polygon(#) | LineString(#) | Total(#) |
| OpenStreetMap | Seoul | 53,404 | 42,639 | 120,256 | 216,299 |
| USGS | pennsylvania | 33,458 | 4,942 | 70,956 | 109,356 |

Here, Open Street Map includes the geometric data about spatial objects in the range of the whole world, and the experiment was conducted using geometric data about “Seoul.” In addition, USGS may include the geometric data about spatial objects in the range of the United States, and the experiment was conducted using geometric data about “Pennsylvania.” The experiment performs an analysis by measuring and comparing the processing time during which spatial knowledge is extracted using the spatial knowledge extractor 1 according to an embodiment of the present invention and the processing time during which spatial knowledge is extracted using a conventional spatial knowledge extractor.

FIG. 11 shows a result of comparing the processing time during which spatial knowledge is extracted using a conventional spatial knowledge extractor (a graph of FIG. 11 in which its interior is displayed in white) and the processing time during which spatial knowledge is extracted using a spatial knowledge extractor according to an embodiment of the present invention (a graph of FIG. 11 in which its interior is displayed in black) by utilizing Open Street Map database. Referring to FIG. 11, upon the extraction of both topological relation knowledge and directional relation knowledge, it can be seen that the performance for the processing time of the spatial knowledge extractor 1 according to an embodiment of the present invention is better than that of the conventional spatial knowledge extractor. It can also be seen that an extraction time of the topological relation knowledge decreased by an average of 87.61% and an extraction time of the directional relation knowledge decreased by an average of 41.28%.

FIG. 12 shows a result of comparing the processing time during which spatial knowledge is extracted using a conventional spatial knowledge extractor (a graph of FIG. 12 in which its interior is displayed in white) and the processing time during which spatial knowledge is extracted using a spatial knowledge extractor according to an embodiment of the present invention (a graph of FIG. 12 in which its interior is displayed in black) by utilizing USGS database. Referring to FIG. 12, upon the extraction of both topological relation knowledge and directional relation knowledge, it can be seen that the performance for the processing time of the spatial knowledge extractor 1 according to an embodiment of the present invention is better than that of the conventional spatial knowledge extractor. It can also be seen that an extraction time of the topological relation knowledge decreased by an average of 97.08% and an extraction time of the directional relation knowledge decreased by an average of 41.42%.

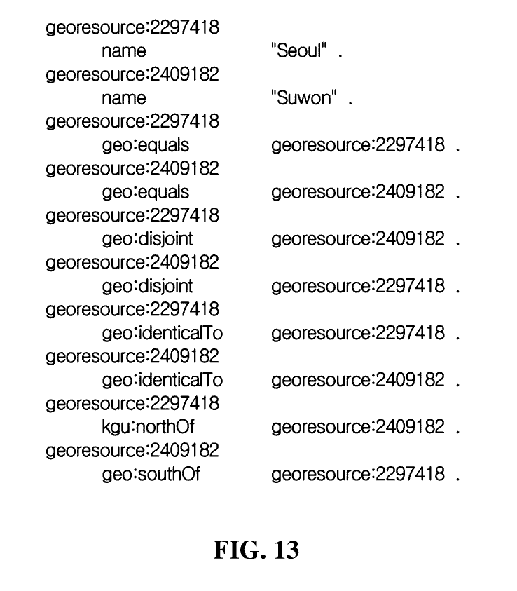

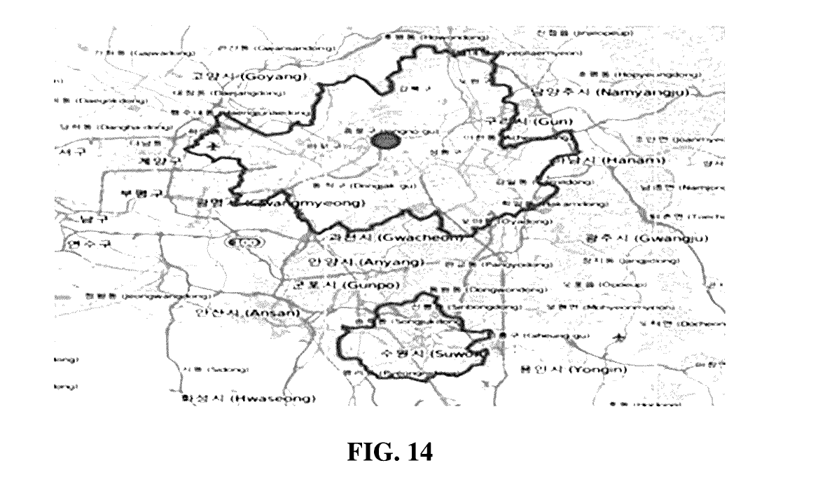

Whether the spatial knowledge extracted by the spatial knowledge extractor 1 according to an embodiment of the present invention is correct will be verified below with reference to FIGS. 13 and 14. FIG. 13 is a diagram showing an example of spatial knowledge about two spatial objects extracted by a spatial knowledge extractor according to an embodiment, and FIG. 14 is a diagram showing actual spatial knowledge about two spatial objects used to extract the spatial knowledge in FIG. 13.

Referring to FIG. 13, spatial knowledge about “Seoul” and “Suwon” extracted by the spatial knowledge extractor 1 according to an embodiment of the present invention includes total eight pieces of spatial relation knowledge of “Seoul is equal to Seoul (Seoul equals Seoul),” “Suwon is equal to Suwon (Suwon equals Suwon),” “Seoul is disjoint from Suwon (Seoul disjoint Suwon),” “Suwon is disjoint from Seoul (Suwon disjoint Seoul),” “Seoul has the same directional relation as Seoul (Seoul identical Seoul),” “Suwon has the same directional relation as Suwon (Suwon identical Suwon),” “Seoul is located in the north of Suwon (Seoul north Suwon),” and “Suwon is located in the south of Seoul.”

Referring to FIG. 14, the spatial relation between Seoul and Suwon may be seen visually on the map. It can be seen from FIG. 14 that the spatial knowledge such as “Seoul is disjoint from Suwon,” “Seoul is located in the north of Suwon,” etc. extracted by the spatial knowledge extractor 1, as shown in FIG. 13, is correct.

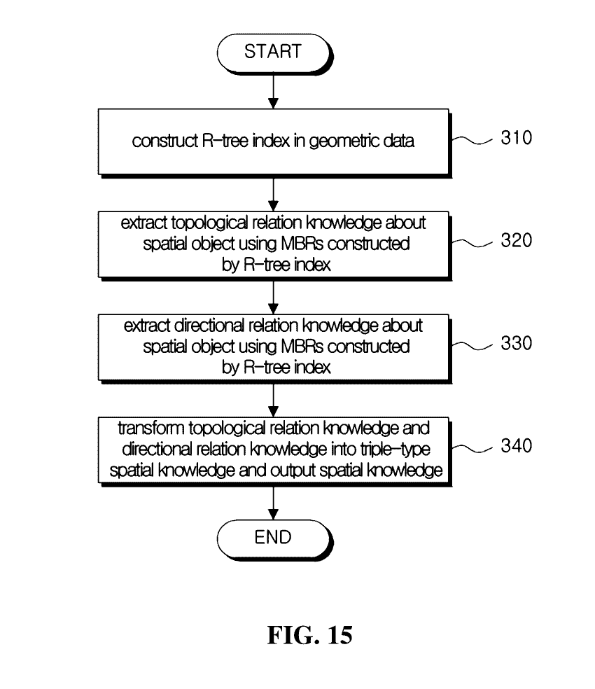

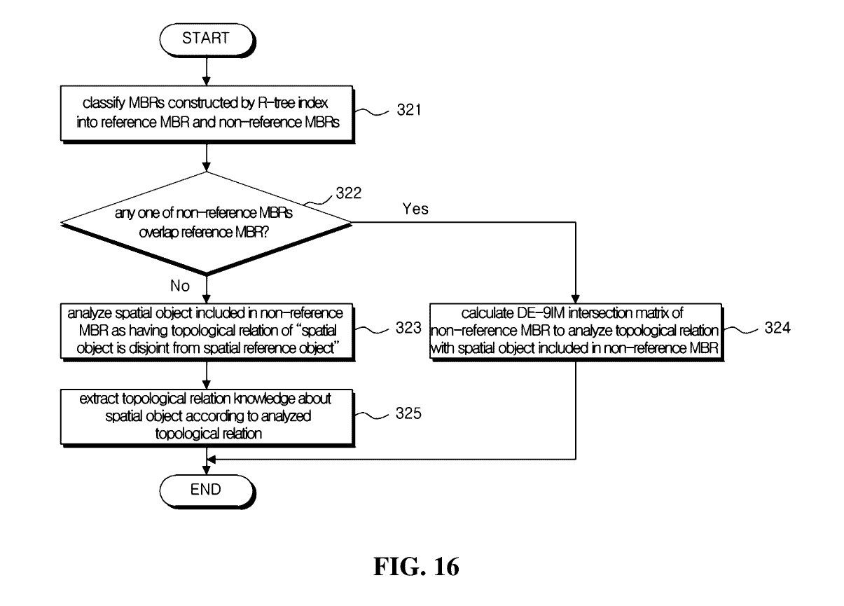

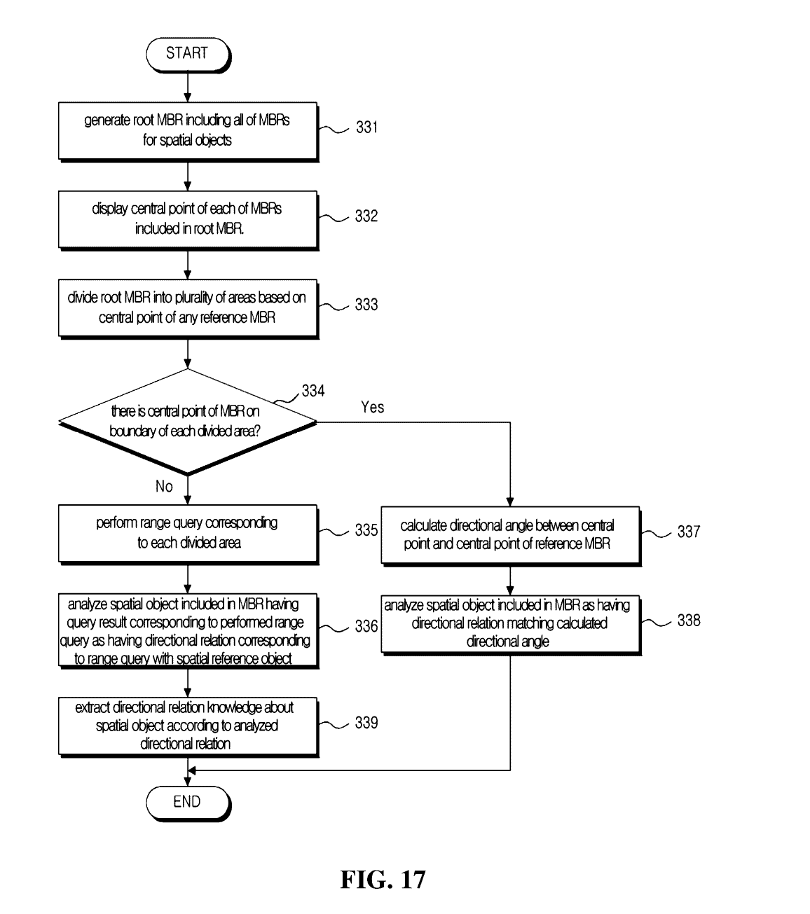

A method of extracting spatial knowledge according to an embodiment of the present invention will be described below with reference to FIGS. 15, 16 and 17. In this case, FIG. 15 is an overall flowchart showing a method of extracting spatial knowledge according to an embodiment of the present invention, FIG. 16 is a detailed flowchart showing a step of extracting a topological relation shown in FIG. 15, and FIG. 17 is a detailed flowchart showing a step of extracting a directional relation shown in FIG. 15.

Referring to FIG. 15, first, the spatial knowledge extraction method includes constructing an R-tree index in geometric data separated from an initial knowledge database by the knowledge parser 110 included in the spatial knowledge extractor 1 according to an embodiment of the present invention (310).

The spatial knowledge extraction method includes extracting topological relation knowledge about a spatial object using minimum bounding rectangles (MBRs) constructed by the R-tree index to surround the spatial object (320). In this case, a method of extracting topological relation knowledge about the spatial object will be described in detail below with reference to FIG. 16.

The spatial knowledge extraction method includes extracting directional relation knowledge about a spatial object using minimum bounding rectangles (MBRs) constructed by the R-tree index to surround the spatial object (330). In this case, a method of extracting directional relation knowledge about the spatial object will be described in detail below with reference to FIG. 17.

The spatial knowledge extraction method includes transforming the extracted topological relation knowledge and directional relation knowledge into triple-type, that is, (s p o)-type spatial knowledge and outputting the spatial knowledge (340).

Referring to FIG. 16, the topological relation knowledge extraction method includes classifying the MBRs constructed by the R-tree index into a reference MBR and non-reference MBRs in order to extract the topological relation knowledge about the spatial object (321).

Here, the reference MBR denotes an MBR including any spatial reference object, and the non-reference MBRs denote MBRs including spatial objects other than the spatial reference object. The spatial reference object may be sequentially selected according to a predetermined selection pattern.

When the MBRs are classified into the reference MBR and the non-reference MBRs (321), the topological relation knowledge extraction method includes determining whether any one of the non-reference MBRs overlap the reference MBR (322).

In this case, the topological relation knowledge extraction method includes analyzing a spatial object included in a non-reference MBR not overlapping the reference MBR as having a topological relation of “the spatial object is disjoint from the spatial reference object” (323).

In addition, the topological relation knowledge extraction method includes calculating a DE-9IM intersection matrix of the non-reference MBR overlapping the reference MBR to analyze the topological relation between the spatial object included in the non-reference MBR and the spatial reference object (324).

The topological relation knowledge extraction method includes extracting the topological relation knowledge about the spatial object according to the topological relation analyzed for the non-reference MBR overlapping the reference MBR and for the non-reference MBR not overlapping the reference MBR (325).

Referring to FIG. 17, the directional relation knowledge extraction method includes generating a root MBR including all of the MBRs constructed by the R-tree index in order to extract the directional relation knowledge about the spatial object (331).

The directional relation knowledge extraction method includes displaying a central point of each of the MBRs included in the generated root MBR (332).

The directional relation knowledge extraction method includes dividing the root MBR into a plurality of areas on the basis of a central point of any reference MBR selected among the MBRs included in the root MBR (333).

Here, the division of the root MBR may include dividing the root MBR into eight total areas according to the nine directional relations (north, north-east, east, south-east, south, south-west, west, north-west, and identical) according to the Cone-Shaped Directional(CSD)-9.

The directional relation knowledge extraction method includes detecting whether there is a central point of an MBR on a boundary of each divided area after dividing the root MBR (334).

The directional relation knowledge extraction method includes performing a range query corresponding to each divided area in order to analyze a directional relation with a spatial object included in an MBR of a central point that is not present on the boundary of each divided area (335).

In this case, the range query is provided in advance for each divided area, and the range query is matched with a directional relation corresponding thereto.

As a result of performing the range query, the directional relation knowledge extraction method includes analyzing a spatial object included in an MBR having a query result corresponding to the performed range query as having a directional relation corresponding to the range query with the spatial reference object (336).

In addition, in order to analyze a directional relation with a spatial object included in an MBR of a central point that is present on a boundary of each divided area, the directional relation knowledge extraction method includes calculating a directional angle between the central point and a central point of the reference MBR (337).

Here, the directional angle is an angle measured on the right side with respect to the north with respect to the north of a Cartesian coordinate system, and a directional relation corresponding to the directional angle is determined and described in Table 2.

When the directional angle between the central point and the central point of the reference MBR is calculated, the directional relation knowledge extraction method includes analyzing the spatial object included in the MBR corresponding to the central point as having a directional relation matching the spatial reference object and the calculated directional angle (338).

The directional relation knowledge extraction method includes extracting directional relation knowledge about the spatial object according to the analyzed directional relation (339).

The technique for extracting spatial knowledge from geometric data using the R-tree index may be implemented as an application or implemented in the form of program instructions that may be executed through various computer components and recorded on a computer-readable recording medium. The computer-readable recording medium may include program instructions, data files, data structures, and the like individually or in combination.

The program instructions recorded on the computer-readable recording medium may be specifically designed for the present invention or may be well known to one skilled in the art of computer software.

Examples of the computer-readable recording medium include a magnetic medium such as a hard disk, a floppy disk, or a magnetic tape, an optical medium such as a compact disc-read only memory (CD-ROM) or a digital versatile disc (DVD), a magneto-optical medium such as a floptical disk, and a hardware device such as ROM, a random access memory (RAM), or a flash memory that is specially designed to store and execute program instructions.

Examples of the program instructions include not only machine code generated by a compiler or the like, but also high-level language codes that may be executed by a computer using an interpreter or the like. The hardware device described above may be constructed so as to operate as one or more software modules for performing the operations of the embodiments of the present invention, and vice versa.

According to an aspect of the present invention, it is possible to reduce the calculation amount used to extract spatial knowledge from geometric data and thus shorten a processing time spent to extract the spatial knowledge from the geometric data by extracting the spatial knowledge including a topological relation and a directional relation between spatial objects from the geometric data using the R-tree index, which is a minimum bounding rectangle (MBR)-based tree data structure.

While the example embodiments of the present invention and their advantages have been described in detail, it should be understood that various changes, substitutions and alterations may be made herein without departing from the scope of the invention.

What is claimed is:

1. A spatial knowledge extractor comprising:
an index builder building an R-tree index for geometric data of a plurality of spatial objects; and
a geometry analyzer comprising:
a topological relation analyzer analyzing a topological relation among the plurality of spatial objects according to whether each of a plurality of minimum bounding rectangles (MBRs) built for each of the plurality of spatial objects by the index builder overlaps with one another, and
a directional relation analyzer performing a range query for each of areas divided with respect to a central point of a first MBR including a spatial reference object among the plurality of MBRs and analyzing a directional relation among the plurality of spatial objects.

2. The spatial knowledge extractor of claim 1, wherein the topological relation analyzer classifies the plurality of MBRs built for the plurality of spatial objects into the first MBR including the spatial reference object and a plurality of second MBRs including a spatial object not overlapped with the spatial reference object, and defines a topological relation of a spatial object of a third MBR as disjointed with the spatial reference object of the first MBR, wherein the third MBR includes the spatial object, not overlapped with the spatial reference object of the first MBR, and the third MBR is included in the plurality of second MBRs.

3. The spatial knowledge extractor of claim 2, wherein the topological relation analyzer analyzes the topological relation by calculating a dimensionally extended nine-intersection model (DE-9IM) intersection matrix of a spatial object of a fourth MBR, wherein the fourth MBR is included in the plurality of second MBRs and the fourth MBR overlaps with the first MBR including the spatial reference object.

4. The spatial knowledge extractor of claim 1, wherein the directional relation analyzer displays a root MBR including a central point of each of the plurality of MBRs built for the plurality of spatial objects by the index builder and the plurality of MBRs built for the plurality of spatial objects by the index builder, divides the root MBR into a plurality of areas according to a directional relation with respect to the central point of each of the plurality of MBRs including the spatial reference object, and performs a range query on each of the plurality of divided areas to analyze the directional relation between the plurality of spatial objects.

5. The spatial knowledge extractor of claim 4, wherein the directional relation analyzer performs a predetermined range query corresponding to each of the areas divided with respect to the central point of the first MBR including the spatial reference object and analyzes a directional relation with the spatial reference object according to a query result of the range query performed on each area.

6. The spatial knowledge extractor of claim 5, wherein, as a result of performing the predetermined range query corresponding to each area, the directional relation analyzer analyzes that all spatial objects included in a corresponding MBR having the query result in response to the range query have a directional relation corresponding to the range query with the spatial reference object.

7. The spatial knowledge extractor of claim 4, wherein when the central point locates on a boundary of each divided area with respect to the central point of the first MBR including the spatial reference object, the directional relation analyzer calculates a directional angle between the central point on the boundary and the central point of the first MBR including the spatial reference object, and analyzes a directional relation with a spatial object included in an MBR corresponding to the central point on the boundary.

8. A method of extracting spatial knowledge, the method comprising:
building an R-tree index for geometric data of a plurality of spatial objects;
analyzing a topological relation among the plurality of spatial objects according to whether each of a plurality of minimum bounding rectangles (MBRs) built for each of the plurality of spatial objects by the R-tree index overlaps with one another; and
performing a range query for each of areas divided with respect to a central point of a first MBR including a spatial reference object among the plurality of MBRs and analyzing a directional relation among the plurality of spatial objects to extract spatial knowledge of the plurality of spatial objects from the geometric data.

9. The method of claim 8, wherein the step of the analyzing further comprises:
classifying the plurality of MBRs built for the plurality of spatial objects into the first MBR including the spatial reference object and a plurality of second MBRs including a spatial object not overlapped with the spatial reference object, and defining a topological relation of a spatial object of a third MBR as disjointed with the spatial reference object of the first MBR, wherein the third MBR includes the spatial object, not overlapped with the spatial reference object of the first MBR, and the third MBR is included in the plurality of second MBRs.

10. The method of claim 9, further comprising calculating a dimensionally extended nine-intersection model (DE-9IM) intersection matrix of a spatial object of a fourth MBR, wherein the fourth MBR is included in the plurality of second MBRs and the fourth MBR overlaps with the first MBR including the spatial reference object.

11. The method of claim 8, wherein the step of the analyzing of the directional relation further comprises: displaying a root MBR including a central point of each of the plurality of the MBRs built for the plurality of spatial objects by an index builder and the plurality of MBRs built for the plurality of spatial objects by the index builder, dividing the root MBR into a plurality of areas according to a directional relation with respect to the central point of each of the plurality of MBRs including the spatial reference object, performing a predetermined range query corresponding to each of the plurality of divided areas, and as a result of performing the range query, analyzing that all spatial objects included in a corresponding MBR having the query result in response to the range query have a directional relation corresponding to the range query with the spatial reference object.

12. The method of claim 11, further comprising, when the central point locates on a boundary of each divided area with respect to the central point of the first MBR including the spatial reference object, calculating a directional angle between the central point on the boundary and the central point of the first MBR including the spatial reference object and analyzing a directional relation with a spatial object included in an MBR corresponding to the central point on the boundary.
